(19) United States
(12) Patent Application Publication
(10) Pub. No.: US 2019/0114858 A1
(43) Pub. Date: Apr. 18, 2019

(54) SYSTEM FOR CONTROLLING ACCESS TO AN EQUIPMENT RACK AND INTELLIGENT POWER DISTRIBUTION UNIT AND CONTROL UNIT USED THEREIN

(71) Applicant: Raritan Americas, Inc., Somerset, NJ (US)

(72) Inventor: Paul MOTT, Somerset, NJ (US)

(21) Appl. No.: 16/153,082

(22) Filed: Oct. 5, 2018

Related U.S. Application Data
(60) Provisional application No. 62/573,106, filed on Oct. 16, 2017.

(51) Int. Cl. G07C 9/00; G06F 1/18; G06F 21/32; G06F 21/34; E05B 47/00

(52) U.S. Cl. CPC G07C 9/00563; G06F 1/189; E05B 47/00; G06F 21/34; G06F 21/32

(57) ABSTRACT

An access control system for controlling access to equipment racks in a data center. Each rack has a door and a latch that can lock the door to prevent access to the equipment in the rack and that can unlock the door to permit such access. Access to the rack (i.e. to the equipment therein) is granted when an authorized service technician causes an identification token (such as a card) to be read by a reading means responsive to the identification token (such as a smart card reader if the identification token is a smart card or an iButton reader if the identification token is an iButton) that is associated with each rack. Alternatively, the reading means can be a biometric sensor that e.g. reads the technician's fingerprint or the technician's retinal eye pattern.

The equipment in the rack can be supplied with power by an intelligent power distribution unit (iPDU). The iPDU has a nonvolatile store in which access information received from the computer network is stored, and the identification means is connected to the iPDU. Locating the access information in the nonvolatile store reduces the demands that the access control system places upon the network and allows the access control system to operate even if the network has been brought down by a power or network failure.

Alternatively, the nonvolatile store can be located in a control unit that is located inside the rack, connected to equipment mounted therein, to the network, and to the reader (e.g. smart card reader, biometric sensor). This alternative likewise reduces the demands that the access control system places upon the network, and allows the access control system to operate even if the network has been brought down by a power or network failure.

### BACKGROUND OF THE INVENTION

The invention relates to access control systems, and more particularly relates to access control systems such as are used to control access to equipment racks in which electrical equipment is mounted. In its most immediate sense, the invention relates to access control systems such as are used in data centers.

Large-scale computer operations are commonly carried out in data centers. A data center is a facility wherein computing tasks are parceled out for execution by a multiplicity—sometimes thousands—of servers (together with related equipment such as modems and routers) that are connected together by one or more networks. Such data processing equipment is conventionally mounted in equipment racks.

Operators of data centers need to secure the equipment in the equipment racks against access by unauthorized persons. This is not only to protect such equipment from tampering, sabotage, etc. It is also because a data center typically has many equipment racks that look identical. If a service technician is directed to e.g. replace a particular server located at a particular position within a particular equipment rack that is located in a facility having thousands of equipment racks, the technician may mistakenly exchange a server located at that position within an adjacent equipment rack. To prevent this from happening, it is known to provide an equipment rack with apparatus that prevents the equipment within the rack from being removed except by a person authorized to do so.

Conventionally, this is done using network-connected access control apparatus that is mounted to each equipment rack. Each service technician is given an identification token (e.g. a smart card, an iButton) that uniquely identifies him or her. When a technician is dispatched to service equipment within a designated rack, that technician presents the token to a mating reader that is mounted to the rack (or is associated with it). The reader reads the token and sends identification information over the data center network to a central system that checks to see whether that person is authorized to service equipment in that particular rack. If so, one or both of the doors of the rack are unlocked, permitting the desired service to be accomplished. Once this has been done, the door(s) is/are locked and remain locked until access is needed subsequently.

Existing systems of this type are not satisfactory. It is inefficient to utilize network resources every time a rack door is opened to install or remove a component; network bandwith should properly be devoted to collecting data regarding operation of the data center and distributing data to the servers, modems, routers, etc. that require it. Additionally, if there is a power or network outage, it may take an unacceptably long time for the network to restore proper operation of the access control apparatus. During this time, equipment located in the equipment racks cannot be serviced.

It would be advantageous to provide an access control system that would not unnecessarily burden the network of a data center. It would further be advantageous to provide an access control system that would not rely on restoration of proper network function after a power or network outage.

The invention proceeds from the realization that it is particularly advantageous for access control information to be stored in a nonvolatile store that is located in, or associated with, the rack to which access is to be controlled. In the presently preferred embodiment, the store is located within a power distribution unit (“PDU”) that supplies electrical power to the equipment mounted in the equipment rack. A nonvolatile store is advantageous because access control information (i.e. the identities of authorized service technicians and the equipment racks each is authorized to service) remains unchanged for long periods of time. Thus, it is only infrequently necessary to update the access control information in the nonvolatile store, and this reduces the demands that the access control system places on the data center network. It is advantageous to locate the nonvolatile store inside the PDU because conventional PDUs are already connected to the data network. However, locating the nonvolatile store inside the PDU is not necessary. It is alternatively possible for the nonvolatile store to be located in a control unit that is located inside the rack. This would be preferred if the control unit were to be required to interface mounted components with the data center network or to e.g. report excessive temperature or humidity conditions inside the rack.

The invention does not require the use of an identification token. In further accordance with the invention, it is alternatively possible to provide the rack with a biometric sensor that e.g. reads a person's fingerprint or retinal eye pattern. This is advantageous because it avoids administrative issues caused by the loss or theft of the identification token.

Advantageously, the PDU is intelligent, i.e. it can e.g. monitor the power consumption of the equipment in the rack and report that information to a central system, turn power to a particular piece of equipment on and off, etc.

### BRIEF DESCRIPTION OF THE DRAWINGS

The invention will be better understood with reference to the following illustrative and non-limiting drawings, in which:

FIG. 1 shows a prior art access control system for controlling access to equipment racks in a data center;

FIG. 2 schematically illustrates a portion of a preferred embodiment of an iPDU 30′ in accordance with the invention that is used in the stead of iPDU 30 in FIG. 1 to convert the FIG. 1 system into a preferred embodiment of the invention;

FIG. 3 shows an alternate embodiment of the invention that uses a control unit 250 mounted inside a rack 10 to be protected; and

FIG. 4 schematically illustrates a portion of the control unit 250 in the alternate embodiment.

### DETAILED DESCRIPTION OF PREFERRED EMBODIMENTS

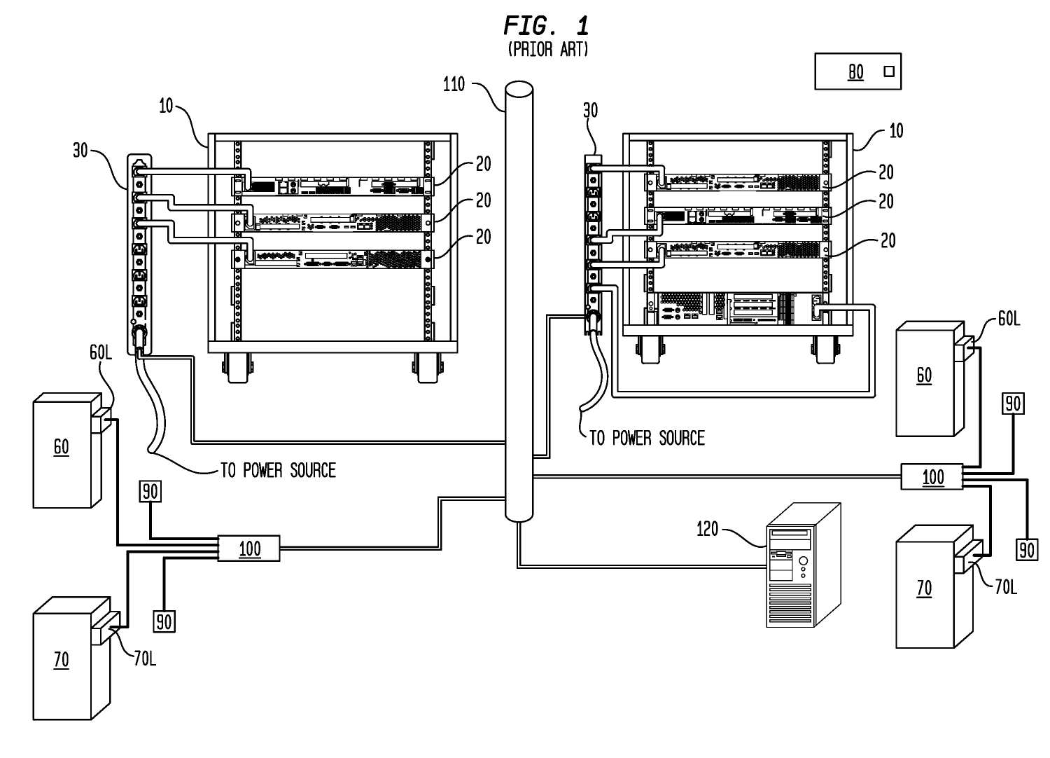

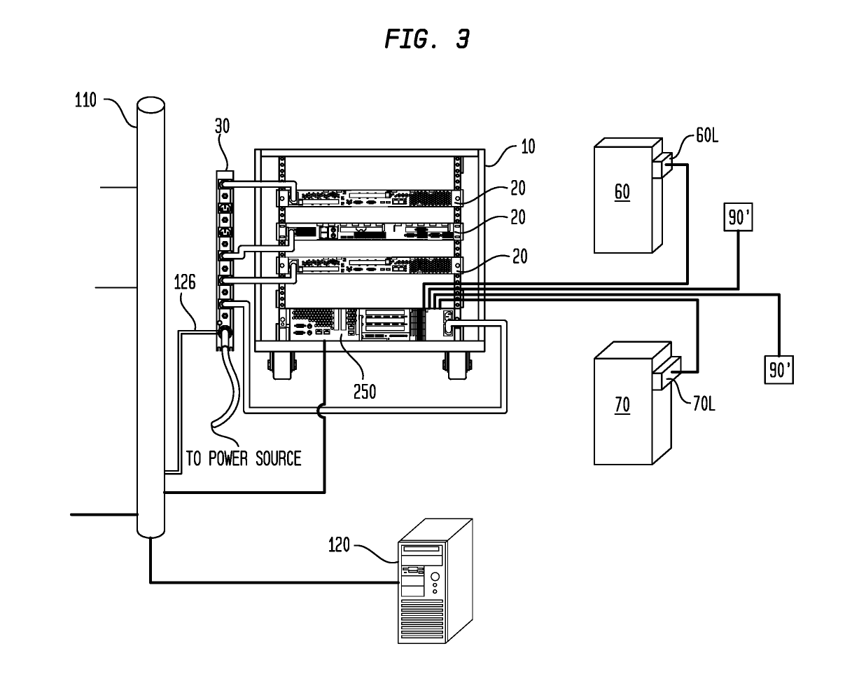

For simplicity, FIG. 1 in the following description shows only two equipment racks in a data center in which a preferred embodiment of the invention has been installed and is operating (and only one equipment rack in the alternate embodiment of FIG. 3). In fact, data centers routinely contain hundreds and even thousands of racks. The number of servers in the data center is not part of the invention. Additionally, the following description does not specify the details of the network(s) used in the data center. Networks are well-known and persons skilled in the art will be able to construct network(s) appropriate to the intended application. Furthermore, the same element is always indicated using the same reference numeral, and corresponding elements in different embodiments are indicated using primed reference numerals.

In a conventional prior art access control system such as is shown in FIG. 1, a rack 10 is constructed to allow a plurality of standard-sized electronic components 20 (e.g. servers, modems, routers) to be mounted inside it. The components 20 are supplied with power by a power distribution unit (“iPDU”) 30 (described in more detail below); the male power plug (not shown) of each component 20 is plugged into a corresponding receptacle (not shown) on the PDU 30, which itself is supplied with power by a power source (not shown). The rack 10 has a front door 60 and a rear door 70.

It is often necessary to install additional components 20 in a particular rack 10 or to replace a failed component 20 with an operable one. To do this, at least one and sometimes both of the doors 60, 70 must be opened. An access control system such as described herein prevents unauthorized persons from being able to access the rack 10 while permitting authorized person to do so. (As used in the art and herein, “access the rack” refers to gaining access to the interior of the rack 10 and to the components 20 mounted therein.) Conventionally, the front door 60 has a front door latch 60L and the rear door 70 has a rear door latch 70L. These latches 60L and 70L can be locked and unlocked electronically; when locked, the corresponding door cannot be opened, and when unlocked the corresponding door can be manually opened. Latches 60L and 70L are known; one known example is manufactured by EMKA Beschlagteile GmbH & Co. KG as Model No. 1150-U56/U58-xx. In such a system, each service technician (not shown) is assigned an identification token that uniquely identifies him or her. In this example, the token is a smart card 80 with an embedded chip or a magnetically-encoded strip, but this is not required. Another token (e.g. an iButton) could be used instead. The smart card 80 or other token can be read by a reader 90; in this example the reader 90 is a smart card reader. In this example, each rack 10 has two readers 90, each associated with one of the doors 60, 70.

Although the latch 60L and its associated reader 90 are shown as separate entities (as are reader 70L and its associated reader 90) are shown as separate entities, they may be part of a single unit. Such units are commercially available.

In this prior art system, the latches 60L and 70L and the readers 90 are connected to an interface 100, and the interface 100 is connected to a computer network 110, which connects all the latches 60L, 70L, readers 90, and interfaces 100 to a central computer 120. The interfaces 100 shown in FIG. 1 are relatively expensive. This is because the signals over the connections between the interfaces 100 and the network 110 typically comply with TCP/IP or other high level network protocols, while the signals over the connections between the interfaces 100 on the one hand and the latches 60L and 70L and readers 90 on the other hand are typically much simpler and can be implemented using a one-wire system. The interfaces 100 need to be expensive because of the complexity involved in translating one of these signal types into the other one. In use, when a service technician (not shown) wishes to access a rack 10, (s)he swipes his/her card 80 through the reader 90 associated with the door 60, 70 to be opened. Identification information from the card 80 is then transmitted to the network 110 via the interface 100, and is routed to the central computer 120. If the technician is authorized to access the rack 10, the central computer 120 issues a command that travels through the network 110 and interface 100 to unlock the door latch 60L, 70L and therefore the 60, 70 that is to be opened. If not, the door latch 60L, 70L and therefore the corresponding door 60, 70 remains closed. If a door 60, 70 has been opened, it is locked after it has been closed and must be unlocked in order to be opened again.

This conventional system has two disadvantages. First, it places an unnecessary burden on the network 110 and central computer 120; each time a door 60, 70 is to be opened or closed a demand is placed on the network 110 and central computer 120. This is disadvantageous; the network 110 bandwidth should properly be devoted to monitoring performance of the data center and meeting the requirements of the components 20; extrinsic administrative functions should be eliminated as much as possible. Second, if the network 110, central computer 120 or both are brought down by a power or network failure, it is impossible to access any of the racks 10 until the network 110 and central computer 120 have been brought back on line.

Each iPDU 30 is also connected to the network 110 and central computer 120. Such a connection is necessary because the iPDU 30 does more than distribute power to the components 20. The iPDU 30 also monitors the power consumption of each of the components 20 to e.g. determine whether a component 20 has failed or is about to fail, so that it can be taken offline and replaced. Such steps require modification of the flow of data to the various components 20.

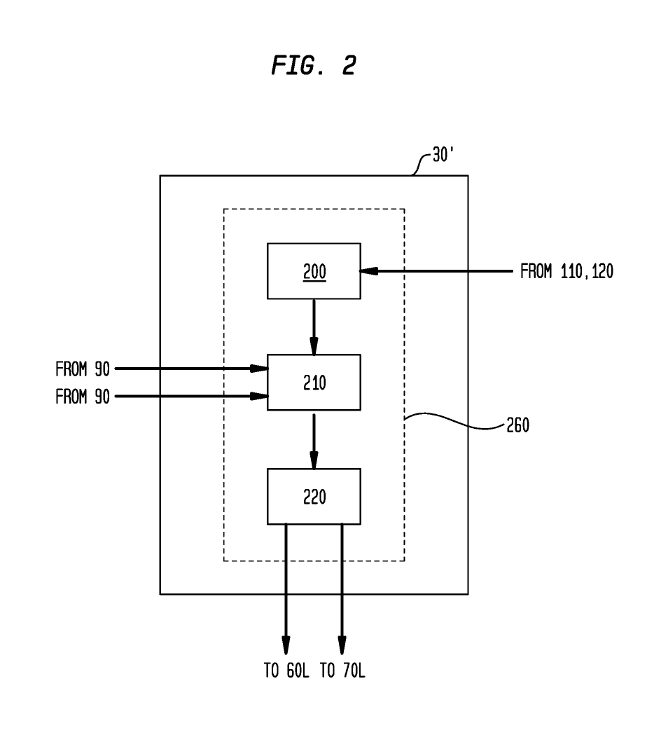

The invention proceeds from the realization that it is advantageous to store access identification information (i.e. information from the central computer 120 specifying which technicians can access which racks 10) in a nonvolatile store 200 such as a read-only memory EEPROM (see FIG. 2). This is because access information does not ordinarily change very often; maintenance staff can remain unchanged for years. By storing access identification information in a nonvolatile store 200, the granting/denial of access to a particular rack 10 can be determined without involvement of the network 110 or central computer 120. In the infrequent event that there is a change in access identification information caused by a change in personnel or by a reassignment of particular people to different locations within the data center, the updated information can be output from the central computer 120 and input to the nonvolatile store 200 by the network 110.

The invention also proceeds from the realization that it is advantageous to locate the nonvolatile store 200 in the iPDU 30′ (FIG. 2). This is because the components 20 in every rack 10 will be powered by a network-connected iPDU 30′.

In accordance with a preferred embodiment of the invention (see FIG. 2), an iPDU 30′ has a nonvolatile store 200 for storing access information received from the central computer 120. The iPDU 30′ also has a means 210 (such as a CPU) for determining whether a particular identification token 80 identifies a person authorized to have access to the rack 10. If so, a means 220 (such as a relay) unlocks the door latches 60L, 70L; if not, the door latches 60L, 70L are kept locked to prevent access to the rack 10.

The store 200, means 210, and means 220 are illustrated as separate entities. They may be separate components, but the functions of the store 200, means 210, and means 220 may be carried out by a controller unit schematically illustrated as controller 260.

This embodiment lacks a counterpart to the interface 100 shown in FIG. 1 and is therefore less expensive.

In a system in accordance with a preferred embodiment of the invention, the iPDUs 30 in FIG. 1 are replaced by the iPDUs 30′ of FIG. 2 and the separate interfaces 100 are eliminated. In this way, the overwhelming number of access authorizations are carried out without involvement of the network 110 and central computer 120 and operation of the access control system does not depend upon operation of those components.

As described above, the service technician can carry a smart card 80 or other identification token, and the reader 90 can be a smart card reader (or other reader that responds to the particular type of token used). This is not required. It is alternatively possible for the reader 90 to be a biometric sensor that responds to e.g. the technician's fingerprints or retinal eye pattern. Further, as discussed above, each reader 90 can be integrated with the latch 60L, 70L to which it corresponds.

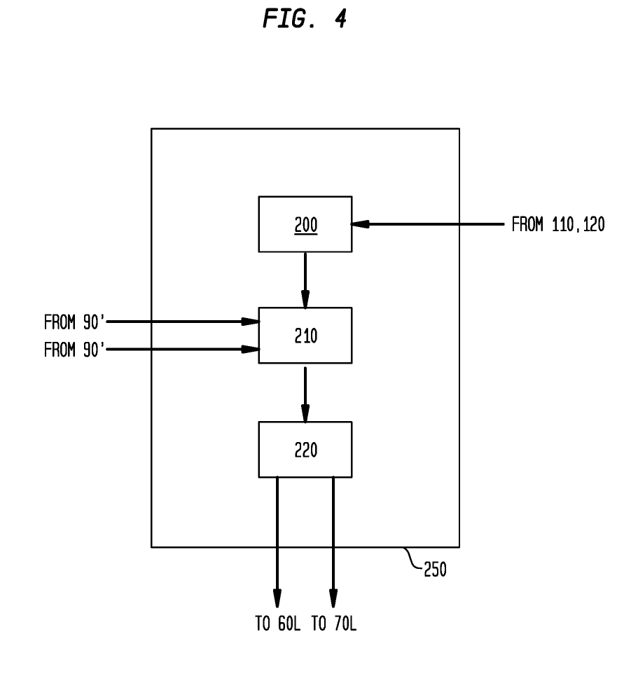

In an alternate embodiment of the invention (FIGS. 3 and 4), a conventional iPDU 30 is used and the nonvolatile store 200 is located within a control unit 250 that is mounted inside the rack 10. This is particularly advantageous when it is desired to monitor the functionality of one or more of the electronic components 20 that are mounted inside the rack 10.

Readers 90′ are used to identify a service technician who is to access the rack. As described above, it is possible for the technician (not shown) to have an identification token such as a smart card or an iButton and in that case the readers 90′ will be smart card or iButton readers. Alternatively, the readers 90′ can be biometric sensors such as are used to detect e.g. an individual's fingerprint or retinal eye pattern. And as stated above, each reader 90; can be part of an integrated unit with its corresponding latch 60L, 70L.

Although at least one preferred embodiment has been described above, this description is not limiting and is only exemplary. The scope of the invention is defined only by the following claims:

1. A system for controlling access to an equipment rack having a door, comprising:
a. a door latch having a locked state and an unlocked state, the door latch permitting the door to be opened when the door latch is in the unlocked state and preventing the door from being opened when the door latch is in the locked state;
b. means for identifying an individual who attempts to access the rack;
c. a computer network adapted to supply access information identifying persons authorized to access the rack;
d. a power distribution unit adapted for supplying electrical power to equipment mounted in the rack, the power distribution unit being operatively connected to the computer network and the reading means and having
i. means for storing, in a nonvolatile store, access information received from the computer network,
ii. means for determining whether the identifying means identifies a person authorized to access the rack, and
iii. means for placing the door latch in its unlocked state when the identifying means identifies a person authorized to access the rack and for maintaining the door latch in its locked state otherwise.

2. A system for controlling access to an equipment rack having a door, comprising:
a. a door latch having a locked state and an unlocked state, the door latch permitting the door to be opened when the door latch is in the unlocked state and preventing the door from being opened when the door latch is in the locked state;
b. means for identifying an individual who attempts to access the rack;
c. a computer network adapted to supply access information identifying persons authorized to access the rack;
d. a control unit mounted inside the rack and connected to equipment mounted therein, the control unit being operatively connected to the computer network and the identifying means and having
i. means for storing, in a nonvolatile store, access information received from the computer network,
ii. means for determining whether the identifying means identifies a person authorized to access the rack, and
iii. means for placing the door latch in its unlocked state when the identifying means identifies a person authorized to access the rack and for maintaining the door latch in its locked state otherwise.

3. The system of claim 1 or 2, wherein the identifying means comprises an identification token and further comprises reader that is responsive to the identification token.

4. The system of claim 1 or 2, wherein the identifying means comprises a biometric sensor.

5. The system of claim 1 or claim 2, wherein the rack has a front door and a rear door, wherein each door has a corresponding door latch and is associated with a corresponding identifying means, and wherein both door latches are placed in the unlocked state when the identifying means identifies a person authorized to access the rack and are maintained in the locked state otherwise.

6. The system of claim 1, wherein the power distribution unit is an intelligent power distribution unit.

7. An intelligent power distribution unit adapted for supplying electrical power to equipment mounted in an equipment rack, the power distribution unit being operatively connectable to a computer network and a means for identifying an individual who attempts to access the rack, and comprising:
a. means for storing, in a nonvolatile store, access information received from the computer network;
b. means for determining whether information read by the identifying means identifies a person authorized to access the rack; and
c. means for placing a rack door latch in an unlocked state when information read by the identifying means identifies a person authorized to access the rack and for maintaining the rack door latch in its locked state otherwise.

8. The intelligent power distribution unit of claim 7, wherein the identifying means comprises an identification token and a reader responsive to the identification token.

9. The intelligent power distribution unit of claim 7, wherein the identifying means comprises a biometric sensor.

10. An access control system for use with a plurality of equipment racks, each rack having a door, comprising:
a. means associated with each rack for identifying an individual who attempts to access a rack;
b. a door latch attached to the door and having a locked state in which the door is locked and an unlocked state in which the door can be opened;
c. a central system storing access information identifying persons authorized to access equipment racks by opening doors thereof;
d. a network connected to the central system;
e. an intelligent power distribution unit associated with each rack, the intelligent power distribution unit being connected to the network and having
i. means for storing, in a nonvolatile store, access information received from the computer network,
ii. means for determining whether information read by the identifying means identifies a person authorized to access the rack, and
iii. means for placing the door latch in an unlocked state when information read by authorized to access the rack and for maintaining the door latch in its locked state otherwise.

11. The system of claim 10, wherein the means for identifying comprises an identification token and a reader responsive to the identification token.

12. The system of claim 10, wherein the means for identifying comprises a biometric sensor.
